(19) United States
(12) Patent Application Publication
(10) Pub. No.: US 2022/0008269 A1
(43) Pub. Date: Jan. 13, 2022

(54) Portable Cleaning Station for Physically Disabled Patients

(71) Applicant: Christine Groethe, Edgewater, CO (US)

(72) Inventor: Christine Groethe, Edgewater, CO (US)

(21) Appl. No.: 17/399,915

(22) Filed: Aug. 11, 2021

Related U.S. Application Data
(63) Continuation-in-part of application No. 16/924,756, filed on Jul. 9, 2020, now Pat. No. 11,103,396.

(51) Int. Cl. A61G 7/00

(52) U.S. Cl. CPC A61G 7/0005; B08B 3/04

(57) ABSTRACT

A portable cleaning station for physically disabled patients includes a curved body, a basin, at least one drain channel, at least one left handle, and at least one right handle. The basin and the at least one drain channel are integrated into the curved body so that gray water from the cleaning process of the disabled patient can be drained and collected as the basin and the at least one drain channel are in fluid communication with each other. The at least one left handle and the at least one right handle are oppositely positioned of each other about a sagittal plane of the curved body. The at least one left handle is perimetrically integrated into the curved body, and the at least one right handle is perimetrically integrated into the curved body thus allowing the curved body to be easily moved in any direction.

The current application is a continuation-in-part (CIP) application of the U.S. non-provisional application Ser. No. 16/924,756 filed on Jul. 9, 2020.

### FIELD OF THE INVENTION

The present invention relates generally to medical stretcher. More specifically, the present invention is a portable cleaning station for physically disabled patients so that the caregivers can properly conduct a bed bath.

### BACKGROUND OF THE INVENTION

Providing caregivers with a safe and discreet way to administer personal hygiene to their patients is vital for both the caregiver and the patient. Keeping the patient clean is important in combating illness and maintaining their self-esteem, while the ability to accomplish this task with safe, quick, and easy facilitation is beneficial for the caregiver, while also maintaining the comfort of the patient. A patient who is bedridden may often find it difficult to maintain their personal hygiene standards by themselves and will, therefore, require the assistance of a caregiver. Generally, a patient is given bed bath or placed within a shower gurney, a shower stall, or a bathtub. However, a bed bath can sometime be limiting as the bed bath is not able to provide proper cleanliness to the patient. The options of a shower gurney, a shower stall, or a bathtub can sometime be difficult and/or unsafe for some patient due to their lack of mobility or may require multiple caregivers.

It is an objective of the present invention to provide a portable cleaning station for physically disabled patients. The present invention is a portable platform that is integrated with a basin, a drain channel, and a drainpipe. The present invention is specifically geared towards cleaning ischial, sacrum, and perineal areas. Overall curvature of the present invention allows the caregiver to securely place the patient within safely and efficiently conduct a bed bath for the physically disabled patients.

### BRIEF DESCRIPTION OF THE DRAWINGS

FIG. 1 is a top perspective view of the present invention.

FIG. 2 is a bottom perspective view of the present invention.

FIG. 3 is a top view of the present invention.

FIG. 4 is a side view of the present invention showing the drainpipe.

FIG. 5 is a side view of the present invention showing the drain channel.

FIG. 6 is a side view of the present invention showing the height difference between the bottom height and the top height.

### DETAIL DESCRIPTIONS OF THE INVENTION

All illustrations of the drawings are for the purpose of describing selected versions of the present invention and are not intended to limit the scope of the present invention.

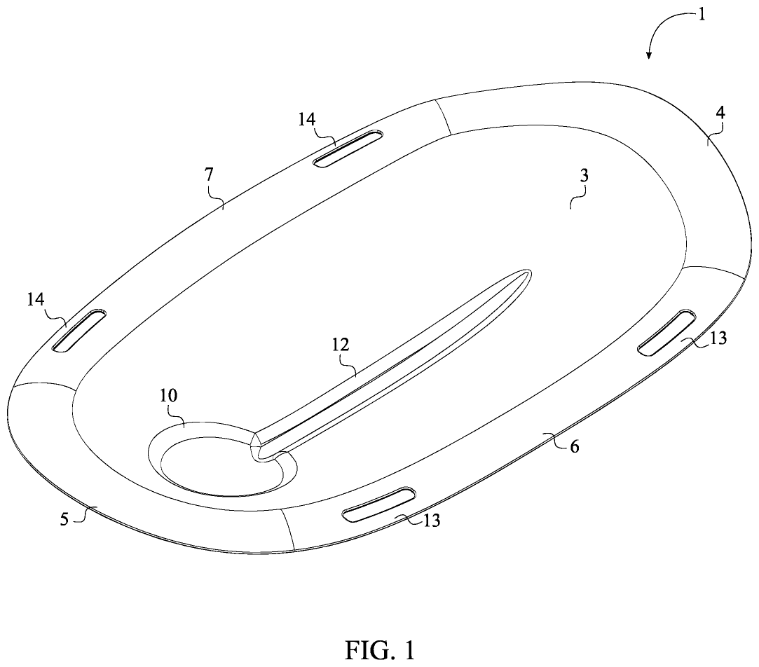

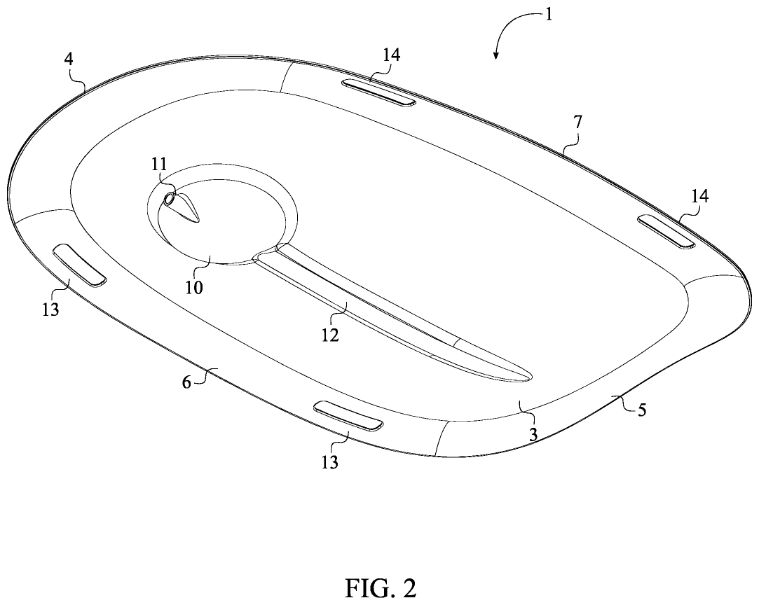

The present invention is a portable cleaning station for physically disabled patients so that the caregivers can safely and efficiently conduct a bed bath for the patients. The present invention provides an upgrade over existing cleaning features such as a shower gurney, a shower stall, or a bathtub. The present invention comprises a curved body 1, a basin 10, at least one drain channel 12, at least one left handle 13, and at least one right handle 14 as shown in FIG. 1-2.

In reference to the general configuration of the present invention, the curved body 1 provides a stable and sufficient surface area to place the patient within. The basin 10 that provides drainage for graywater is integrated into the curved body 1 as the patient is placed on top of the curved body 1. The at least one drain channel 12 is integrated into the curved body 1 so that graywater can be drained into the basin 10 during the cleaning process, wherein the basin 10 and the at least one drain channel 12 are in fluid communication with each other. The at least one left handle 13 and the at least one right handle 14 are oppositely positioned of each other about a sagittal plane 2 of the curved body 1 thus providing designated areas to grasp and maneuver the curved body 1. More specifically, the at least one left handle 13 is perimetrically integrated into the curved body 1, and the at least one right handle 14 is perimetrically integrated into the curved body 1 so that the curved body 1 can be held from left side and right side.

In reference to FIG. 1-3, the curved body 1 comprises a torso resting section 3, a top lip 4, a bottom lip 5, a left lip 6, and a right lip 7. The exact curvature of the curved body 1 is determined in order to fully drain graywater towards the basin 10 and to provide optimal comfort for the patient. The torso resting section 3 functions as the platform that supports the patient's back so that the patient can be placed upon the present invention. The left lip 6 and the right lip 7 are oppositely positioned of each other across the sagittal plane 2 so that the left lip 6 is adjacently connected to the torso resting section 3, and the right lip 7 is adjacently connected to the torso resting section 3. The top lip 4 and the bottom lip 5 are oppositely positioned of each other along the sagittal plane 2. As a result, the top lip 4 is adjacently connected to the torso resting section 3 and terminally connected to the left lip 6 and the right lip 7. Similarly, the bottom lip 5 is adjacently connected to the torso resting section 3 and terminally connected to the left lip 6 and the right lip 7. More specifically, the top lip 4, the bottom lip 5, the left lip 6, and the right lip 7 collectively function as the outermost lip so that the graywater can stay within the curved body 1 and drain into the basin 10 without overflowing around the parameter of the curved body 1. Furthermore, the top lip 4 is an upper section of the curved body 1 and allows the patient to rest their head. The bottom lip 5 is a lower section of the curved body 1 and allows the patient to rest their legs.

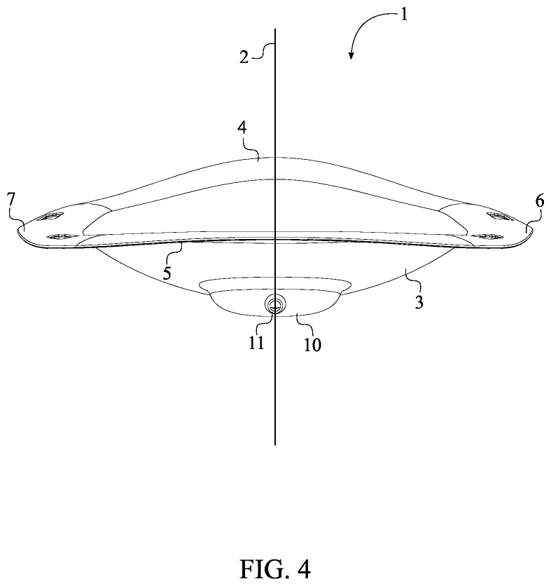

In reference to FIG. 2 and FIG. 4, the basin 10 is connected into the torso resting section 3 and adjacently positioned to the bottom lip 5. In other words, the basin 10 is designed to align with patient's ischial, sacrum, and perineal areas that generally requires additional cleaning steps. Furthermore, the present invention further comprises a drainpipe 11 that is in fluid communication with the basin 10. The drainpipe 11 discharges graywater from the basin 10 into an existing discharging outlet such as a toilet, a shower drain of a bathroom, or a portable reservoir.

Optionally, the present invention can comprise a flow control valve to control the drainage of graywater from the basin 10. More specifically, the drainpipe 11 and the basin 10 are in fluid communication with each other through the flow control valve so that the caregivers can control the drainage of graywater. For example, when the basin 10 needs to be filled with clean water, the flow control valve can be configured to a closed position thus allowing clean water to collect within the basin 10. When the graywater needs to continuously discharge from the basin 10, the flow control valve can be configured to an opened position.

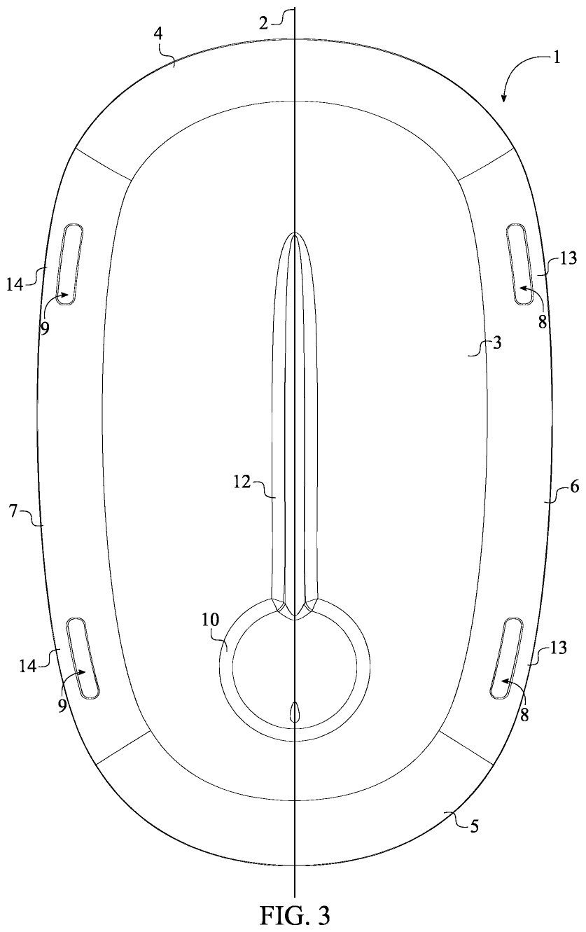

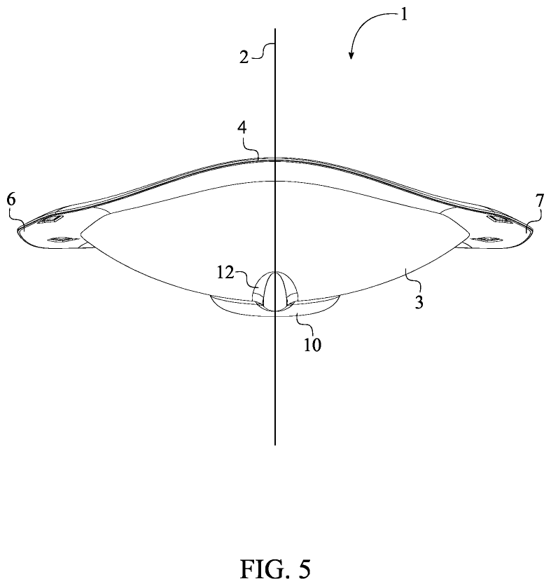

In reference to FIG. 3 and FIG. 5, the at least one drain channel 12 that allows graywater to be drain into basin 10 also aids to prevent spillage of graywater from the parameter of the curved body 1. More specifically, the at least one drain channel 12 is connected into the torso resting section 3 and extended along the sagittal plane 2. Furthermore, the at least one drain channel 12 is positioned in between the left lip 6 and the right lip 7 to maximize the drainage of graywater from both sides of the sagittal plane 2.

In reference to FIG. 3, the curved body 1 further comprises at least one left opening 8. More specifically, the at least one left opening 8 traverses through the left lip 6 so that the at least one left handle 13 can be delineated. As a result, the caregivers can insert their fingers through the at least one left opening 8 to firmly grasp the curved body 1 from the left side. In the preferred embodiment of the present invention the at least one left opening 8 is a first left opening and a second left opening, wherein the first left opening is positioned adjacent to the top lip 4 and the second left opening is positioned adjacent to the bottom lip 5. As a result, the preferred embodiment provide a pair of left handle as the at least one left handle 13 thus providing two separate handles for the caregivers.

In reference to FIG. 3, the curved body 1 further comprises at least one right opening 9. More specifically, the at least one right opening 9 traverses through the right lip 7 so that the at least one right handle 14 can be delineated. As a result, the caregivers can insert their fingers through the at least one right opening 9 to firmly grasp the curved body 1 from the right side. In the preferred embodiment of the present invention the at least one right opening 9 is a first right opening and a second right opening, wherein the first right opening is positioned adjacent to the top lip 4 and the second right opening is positioned adjacent to the bottom lip 5. As a result, the preferred embodiment provide a pair of right handle as the at least one right handle 14 thus providing two separate handles for the caregivers.

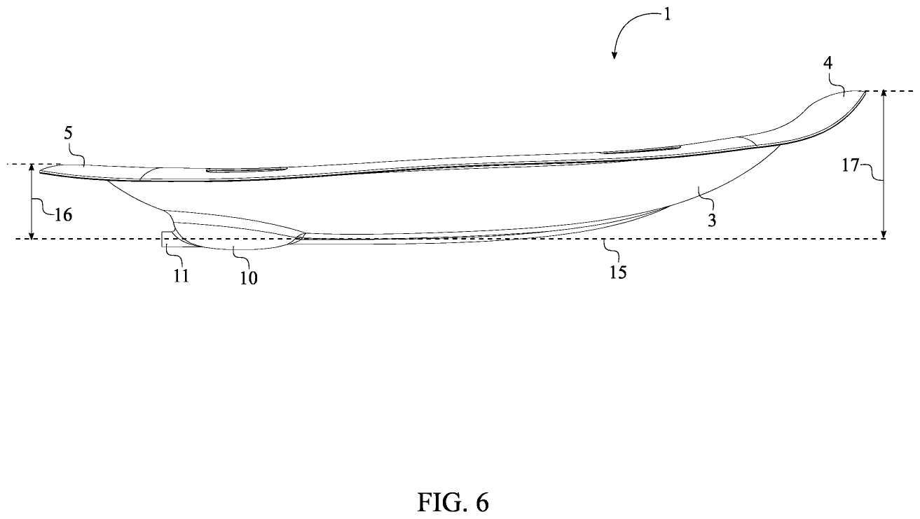

In reference to FIG. 6, the present invention further comprises a central axis 15, a bottom height 16, and a top height 17 so that the curvature of the curved body 1 can be defined. More specifically, the central axis 15 is concentrically positioned within the drainpipe 11 to delineate a reference line. The bottom height 16 is delineated from the central axis 15 to a topmost surface end of the bottom lip 5. The top height 17 is delineated from the central axis 15 to a topmost surface end the top lip 4. The top height 17 is greater than the bottom height 16 so that the patient's head can be tilted in comparison to the positioning of the patient's leg.

The present invention optionally comprises a handheld bidet system is operatively connected into the curved body 1 so that the caregiver can easily access the handheld bidet system to discharge a flow of clean water. Furthermore, the handheld bidet system can be adjacently positioned to the bottom lip 5 so that the handheld bidet system can be operated without tangling around the patient's body. The handheld bidet system may comprise a spray nozzle and a flexible hose thus providing a source of clean water to the present invention. More specifically, a female end of the flexible hose is attached to an existing waterspout or any other industry standard water outlets thus enabling a flow of clean water to enter into the flexible hose. A male end of the flexible hose is in fluid communication with the spray nozzle so that the flow of clean water can be discharged through the spray nozzle.

The present invention can also optionally utilize with a stabilizing base structure that can be removably mounted to the curved body 1 or build into the curved body 1. More specifically, the stabilizing base structure provides a stable platform for the present invention to overcome the curvature of the curved body 1 when the curved body 1 is placed on a flat surface.

Although the invention has been explained in relation to its preferred embodiment, it is to be understood that many other possible modifications and variations can be made without departing from the spirit and scope of the invention as hereinafter claimed.

What is claimed is:

1. A portable cleaning station for physically disabled patients comprising:
a curved body;
a basin;
at least one drain channel;
at least one left handle;
at least one right handle;
the basin being integrated into the curved body;
the at least one drain channel being integrated into the curved body;
the basin and the at least one drain channel being in fluid communication with each other;
the at least one left handle and the at least one right handle being oppositely positioned of each other about a sagittal plane of the curved body;
the at least one left handle being perimetrically integrated into the curved body; and
the at least one right handle being perimetrically integrated into the curved body.

2. The portable cleaning station for physically disabled patients as claimed in claim 1 comprising:
the curved body comprising a torso resting section, a top lip, a bottom lip, a left lip, and a right lip;
the left lip and the right lip being oppositely positioned of each other across the sagittal plane;
the left lip being adjacently connected to the torso resting section;
the right lip being adjacently connected to the torso resting section;
the top lip and the bottom lip being oppositely positioned of each other along the sagittal plane;
the top lip being adjacently connected to the torso resting section;
the top lip being terminally connected to the left lip and the right lip;
the bottom lip being adjacently connected to the torso resting section; and
the bottom lip being terminally connected to the left lip and the right lip.

3. The portable cleaning station for physically disabled patients as claimed in claim 1 comprising:
the curved body comprising a torso resting section and a bottom lip;
the basin being connected into the torso resting section; and
the basin being adjacently positioned to the bottom lip.

4. The portable cleaning station for physically disabled patients as claimed in claim 1 comprising:
the curved body comprising a torso resting section, a left lip, and a right lip;
the at least one drain channel being connected into the torso resting section;
the at least one drain channel being extended along the sagittal plane; and
the at least one drain channel being positioned in between the left lip and the right lip.

5. The portable cleaning station for physically disabled patients as claimed in claim 1 comprising:
the curved body comprising a left lip and at least one left opening;
the at least one left opening traversing through the left lip; and
at least one left handle being delineated by the at least one left opening and the left lip.

6. The portable cleaning station for physically disabled patients as claimed in claim 1 comprising:
the curved body comprising a right lip and at least one right opening;
the at least one right opening traversing through the right lip; and
at least one right handle being delineated by the at least one right opening and the right lip.

7. The portable cleaning station for physically disabled patients as claimed in claim 1 comprising:
a drainpipe; and
the drainpipe is in fluid communication with the basin.

8. The portable cleaning station for physically disabled patients as claimed in claim 7 comprising:
a central axis;
a bottom height;
a top height;
the curved body comprising a top lip and a bottom lip;
the central axis being concentrically positioned within the drainpipe;
the bottom height being delineated from the central axis to the bottom lip;
the top height being delineated from the central axis to the top lip; and
the top height being greater than the bottom height.
